(19) United States
(12) Patent Application Publication
(10) Pub. No.: US 2018/0091553 A1
(43) Pub. Date: Mar. 29, 2018

(54) METHODS AND DEVICES FOR PROTECTING NETWORK ENDPOINTS

(71) Applicant: QUALCOMM Incorporated, San Diego, CA (US)

(72) Inventors: Giridhar Mandyam, San Diego, CA (US); Dallas James Wiener, San Diego, CA (US)

(21) Appl. No.: 15/274,025

(22) Filed: Sep. 23, 2016

(51) Int. Cl. H04L 29/06; H04W 74/06

(52) U.S. Cl. CPC H04L 63/20; H04W 74/06; H04L 63/14

(57) ABSTRACT

Various embodiments provide methods, devices, and non-transitory processor-readable storage media enabling dynamically modifying the polling frequency of endpoint devices within an endpoint protection system. Various embodiments may include determining, by an endpoint device of a network environment, whether communication device endpoint protection is active on the endpoint device. That is, the endpoint device may check to ensure that anomaly detection software, device health monitors, or other malware detection is in active operation. The endpoint device may adjust, modify, or alter the frequency with which it transmits polling messages to a network server based, at least in part, on a result of the determination as to whether communication device endpoint protection is active. For example, if the endpoint device determines that communication device endpoint protection is active, the endpoint device may reduce the polling frequency.

### BACKGROUND

Mobile devices, particularly handsets, may pose challenges with respect to server-controlled endpoint detection methods. This is because such devices may experience intermittent connectivity, or may be behind a firewall, power-limited, and/or bandwidth-constrained. However, an Endpoint Protection Control Center (EPCC) often requires the functionality necessary to contact endpoints in order to query their status. Such inquiries may be necessary for a number of reasons, depending on the nature of an event detected by the EPCC or in systems in communication with the EPCC. For example, if the EPCC detects suspicious traffic patterns emanating from the endpoint device, as may be detected within a connected corporate infrastructure, the EPCC may query the endpoint device for an activity report. Depending on the method of implementation, such queries may result in continuous client-originated polling.

### SUMMARY

Various embodiments include methods, as well as computing devices and servers implementing such methods, for modifying a polling frequency in an endpoint computing device within a communications network based upon whether the computing device implements communication device endpoint protection or the presence of a threat.

Some embodiments may include determining, by a computing device at an endpoint within a communication network (an “endpoint device), whether communication device endpoint protection is active on the endpoint device, and adjusting a polling frequency associated with the endpoint device based at least in part on whether communication device endpoint protection is active on the endpoint device. Such embodiments may further include polling, by a transceiver of the endpoint device, a network server for security information, receiving the requested security information from the network server, and adjusting the polling frequency of the endpoint device based at least in part on the received security information. In such embodiments, the received security information may include information regarding whether the endpoint device is subject to network-based security measures, suspicious endpoint device characteristics, and suspicious network activity. In such embodiments, the received security information includes a request for a security status report. Such embodiments may further include polling, by the endpoint device, the network server for updated security information at time intervals equal to the adjusted polling frequency. Such embodiments may further include receiving an instruction to modify the polling frequency from the network server, and adjusting the polling frequency of the endpoint device based, at least in part, on the received instruction. In such embodiments, the instruction may be generated by the network server based, at least in part, on an analysis of the security information. In such embodiments, the polling frequency is a frequency at which the endpoint device polls a network server for security information.

Some embodiments may include determining, by a server, based, at least in part, on a received endpoint device status report whether communication device endpoint protection is active on the endpoint device, adjusting, by the server, a polling frequency associated with the endpoint device based at least in part on a result of determining whether communication device endpoint protection is on the endpoint device, and transmitting the adjusted polling frequency from the server to the endpoint device. Such embodiments may further include determining, by the server, whether there is suspicious network activity, and adjusting, by the server, the polling frequency associated with the endpoint device based at least in part on a result of determining whether there is suspicious network activity. In such embodiments, determining whether there is suspicious network activity further may include detecting, by the server, one or more of unusual network traffic patterns, unusual authentication transactions, or unusual authorization transactions. In such embodiments, adjusting the polling frequency associated with the endpoint device may include increasing the polling frequency in response to determining that communication device endpoint protection is not active on the endpoint device. In such embodiments, adjusting the polling frequency may include decreasing the polling frequency in response to determining that communication device endpoint protection is active on the endpoint device. Such embodiments may further include determining, by the server, whether there are any suspicious endpoint device characteristics, and adjusting, by the server, the polling frequency based, at least in part, on a result of determining whether there are any suspicious endpoint device characteristics. Such embodiments may further include determining, by the server, whether the endpoint device is subject to network-based security measures, and adjusting the polling frequency associated with the endpoint device based at least in part on a result of determining whether the endpoint device is subject to network-based security measures.

Further embodiments include a computing device configured to function as an endpoint device in a communication network, the computing device having a processor configured with processor-executable instructions to perform operations of the method summarized above. Further embodiments include a server configured to function within a communication network, the server having a processor configured with processor-executable instructions to perform operations of the method summarized above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the various embodiments.

FIG. 1 is a communications system block diagram of a network suitable for use with the various embodiments.

FIG. 2 is a block diagram illustrating a communications device according to various embodiments.

FIG. 3 is a block diagram illustrating interactions between a communications device and a network for endpoint polling according to various embodiments.

FIG. 4 is a process flow diagram illustrating a method for modifying endpoint polling within an endpoint protection system according to various embodiments.

FIG. 5 is a process flow diagram illustrating a method for modifying endpoint polling within an endpoint protection system according to various embodiments.

FIGS. 6A and 6B are process flow diagrams illustrating methods for modifying endpoint polling frequencies within an endpoint protection system according to various embodiments.

FIG. 7 is a process flow diagram illustrating a method for modifying endpoint polling within an endpoint protection system according to various embodiments.

FIG. 8 is a component block diagram of a communications device suitable for implementing some embodiments.

FIG. 9 is a component block diagram of an example server computer suitable for use with the various embodiments.

### DETAILED DESCRIPTION

Various embodiments and implementations will be described in detail with reference to the accompanying drawings. Wherever possible, the same reference numbers will be used throughout the drawings to refer to the same or like parts. References made to particular examples and implementations are for illustrative purposes, and are not intended to limit the scope of the disclosure or the claims.

The terms “endpoint device”, “communications device,” and “computing device” are used interchangeably herein to refer to any one or all of cellular telephones, smart phones, personal or mobile multi-media players, personal data assistants (PDAs), laptop computers, tablet computers, smart books, palm-top computers, wireless electronic mail receivers, multimedia Internet enabled cellular telephones, wireless gaming controllers, and similar personal electronic devices that include a programmable processor, memory, and circuitry for establishing wireless communications pathways and transmitting/receiving data via wireless communications pathways. Various aspects may be useful in communications devices, such as mobile communications devices (e.g., smart phones), and so such devices are referred to in the descriptions of various embodiments.

The terms “communications device characteristics” or “endpoint device characteristics” are used interchangeably herein to refer to any one or all of device operating system type and version, hardware make and model, software applications and versions, interface type, communications protocol availability and activity, and the like. For example, software application activity may include web browsing history, downloads, browsing security settings, etc. Similarly, communication protocol activity may include history of connection via specific communications protocols, or to specific access points.

Communications devices, such as mobile communications devices (e.g., smart phones), may use a variety of interface technologies, such as wired interface technologies (e.g., Universal Serial Bus (USB) connections, etc.) and/or air interface technologies (also known as radio access technologies)(e.g., Third Generation (3G), Fourth Generation (4G), Long Term Evolution (LTE), Edge, Bluetooth, Wi-Fi, satellite, etc.). Communications devices may establish connections to a network, such as the Internet, via more than one of these interface technologies at the same time (e.g., simultaneously). For example, a mobile communications device may establish an LTE network connection to the Internet via a cellular tower or a base station at the same time that the mobile communications device may establish a wireless local area network (WLAN) network connection (e.g., a Wi-Fi network connection) to an Internet-connected Wi-Fi access point.

Various embodiments may enable a modification in frequency of security information reporting, based, at least in part, on the availability of one or more of on-device/local security screening; network-based security screening; device characteristics and network traffic characteristics. The presence of local/on-device security screening and network-based security screening may indicate that the endpoint device poses less of a security risk than devices without such security mechanisms. Similarly, endpoint devices that have few or no suspicious/malicious device characteristics may pose a reduced security risk. Similarly, network traffic characteristics may determine a level of security risk. For example, detecting suspicious network activity may indicate that there is an increased security risk requiring extra security measures. Suspicious network activity may be detected directly or suspected based upon network events and contextual information. For example, a security threat reported or known elsewhere (i.e., outside the network) may indicate a heightened risk that such a threat could spread or be introduced to the network. As another example, various context information (e.g., devices on the network, activities on the network, etc.) may suggest or indicate that there is a threat or a threat could be developed. The combination of these factors may be analyzed to determine an appropriate frequency for security information reporting by the endpoint device based, at least in part, on the security risk that the endpoint device poses to the network.

In the various embodiments, the frequency with which an endpoint device reports security information to a user may be adjusted by modifying a security information “polling” strategy. The various embodiments may enable an endpoint device to reduce the frequency with which it provides security information to a network security system, such as an Endpoint Protection Control Center (EPCC).

Traditional polling techniques used in a stateless endpoint protection system enable client programs running on computing devices to selectively check the status of or request data from an external device. In client/server configurations, client devices may transmit polling messages to a server over a network in order to solicit data from the server rather than waiting for a push message from the server. Client computing devices may employ interval-based techniques in which a client program may transmit a data request at set intervals regardless of the length of time between server responses. Alternatively, client programs may implement timeout routines, such as recursive poll message transmissions, in which each new polling message is not transmitted until the client program receives a server response to a previous message, at which time the client program initiates a new polling transmission.

Long polling is a variation on traditional polling techniques, in which client programs may request data from the server with the expectation that the server may not yet have the requested data. If the server has no new information for the client when the server receives the polling message, the server may hold the request open and may await an availability of the requested data. Once the requested data becomes available, the server may send a response to the client (e.g., a Secure HTTP (HTTP/S) response), completing the open request. This technique may reduce or eliminate the transmission of empty responses from the server to the client computing device. When the client program of the computing device receives the server response, the client program may transmit another polling message, thereby creating a new open request for data to be filled the next time new data becomes available to the server. By using open data requests that remain active on a server, long polling techniques may reduce the time between when the information first becomes available and the next client request (i.e., response latency).

Many HTTP-based communications methods leverage AJAX (asynchronous Javascript and XML) due to its simplicity and universality. AJAX services are normally designed using Representational State Transfer, or REST, principles (the term “RESTful” may be used to characterize an AJAX-based service following REST methodology). AJAX services that are RESTful are, in general, stateless. For example, a single request coupled with a corresponding response may complete a networking transaction. However, certain classes of services may require persistent Internet Protocol (IP)-based connections. Such applications may listen for server-originated data pushes. Endpoint protection is an example of a service in which an Endpoint Protection Control Center (“EPCC”) may request a status report from a remote device, resulting in continuous client-originated polling.

Polling by endpoint devices within a network may require the transmission of a polling message, receipt of information or a status report request, transmission to the server of status information, and the subsequent analysis of the received response data by the network server. Polling by endpoint devices may require communications and processing resources to transmit regular polling messages, as well as to prepare and transmit status reports to the polling EPCC. Thus, the frequency with which endpoint devices poll network servers may have a cumulative negative impact on endpoint device performance, because transmitting unnecessary polling messages may tie up endpoint processing and communications resources and consume battery life. Dynamic modification of the frequency with which an EPCC (i.e., network server) is polled by an endpoint device may enable more efficient use of endpoint device hardware resources and may reduce unnecessary battery life consumption. Dynamic modification of polling frequencies may be based, at least in part, on a determined security threat posed by the endpoint device and/or the overall environment within which the device resides. Endpoint device characteristics and network traffic may warrant adjustment of polling frequency as these factors may impact the overall security risk posed by an endpoint device. Endpoint devices that are associated with a lower determined security threat require less monitoring by an EPCC, and as a result, may require less frequent polling. Polling frequency for security related information from end point devices may become an issue for power-limited endpoint devices, such as mobile communication devices (e.g., smartphones). The frequency of polling (or polling frequency) may impact battery life; the more frequently poling is performed, the faster the battery will be drained. On the other hand, in a connectionless implementation method, such as those supported by hypertext transfer protocol (HTTP), a coarse polling frequency may result in a lack of timeliness in responding to EPCC-initiated actions, such as reporting queries.

Selection of a suitable polling frequency is not always performed with consideration of mobile devices in conventional system. For example, some conventional systems use fixed or default values for the network-polling frequency for system status reporting, in which the fixed or default values depend on the type of endpoint device. In other words, the type of connectivity (wireless, wireline, etc.) is not considered when determining the polling frequency. Such static polling frequency approaches may be suitable for typical enterprise endpoint management solutions that involve fixed network access and few limits on power resources. However, mobile devices have limited power resources and consequently frequent or continuous polling communications may impact usage and the user experience. Reducing endpoint device polling frequencies may enable a reduction in the associated bandwidth utilization and power consumption, of endpoint devices that have their own protection systems or capabilities.

Various embodiments include methods that modify the frequency with which an endpoint device polls a network server for security information reporting requests, based, at least in part, on one or more of the availability of communication device endpoint protection, network-based security measures, endpoint device characteristics, and network traffic characteristics. In various implementations, endpoint devices and network servers (e.g., EPCC) within a network environment may contribute to an endpoint protection system through an exchange of information about the security of both endpoint devices and the network as a whole. Implementations of the endpoint protection system may include the performance of operations by one or both endpoint devices and the network server.

In various embodiments, communication device endpoint protection 1 may be on-device or local security screening mechanisms that provide an endpoint device with some measure of increased security. For example, communication device endpoint protection may take many forms including anomaly detection applications for smartphones, such as antivirus software. Communication device endpoint protection may be real-time malware detection, device health monitoring, or another malicious or performance-degrading behavior detection application. Such applications may detect malware on an endpoint device by identifying signatures, such as known byte sequences associated with malware. Such malware detection may not detect certain malware, as bad actors may resort to obfuscation and other code hiding techniques that alter the code signature. To compensate for signature identification shortcomings, some malware detection applications utilize model-based runtime behavior analysis. By examining runtime behaviors, such as application program interface (API) calls and other runtime operations, behavior associated with malware can be detected using machine learning-derived models.

In addition, communication device services that verify the “health” of the communication device, such as the Android™ SafetyNet service, may enable an application to query a status of the device on which it is installed. Such applications may obtain a token indicating whether the communication device passes certain Android compatibility tests. The application may also provide information to verify the integrity of the SafetyNet service itself in the token. The token may be passed to a cloud-based service (e.g., an Internet-accessible remote server) to complete the confirmation of SafetyNet integrity.

A communication device with endpoint device protection, such as runtime malware detection or device health attestation, may require less frequent server-based security monitoring than a device without local communication device protections. Further, communication device endpoint protection applications may be triggered to notify an EPCC, such as a network server, upon detection of a security risk without waiting for EPCC security status queries. However, EPCC initiated reporting may still be required to account for network-based security measures.

In various embodiments, network-based security measures may include security screening mechanisms implemented by a network server in order to detect malicious, anomalous, or network-degrading behaviors. For example, network-based security measures may include the identification in network infrastructure (e.g. routers, access management systems) of suspicious network activity. Suspicious network activity may include unusual traffic patterns or unusual authentication or authorization transactions originating from a communication device. A communication device without similar built-in security measures may have to rely on network-based methods for tamper or malware detection. A network-triggered endpoint protection mechanism may include a pushed status query from an EPCC upon anomaly detection to verify the status of the endpoint device.

Additionally, an EPCC (e.g., a network server) may adjust a polling frequency based on an availability of network-based security measures. For instance, an EPCC without access to network-based security measures may require more frequent polling of all endpoints, because the EPCC may push more frequent status report requests than an EPCC implementing network-based security measures.

Various embodiments may further consider the device characteristics of an endpoint device when determining whether to adjust security information reporting rates. For example, the characteristics and features of an endpoint device may include device make and model, manufacturer, web-browsing history, software application version, download history, wireless protocols enabled, etc. Information about each of these factors may be received by the endpoint device and/or the network server. The information may be used to adjust the frequency with which the endpoint device provides security information updates to a network server.

Various embodiments may further consider network traffic characteristics, such as ongoing or recent suspicious network activity, when determining whether to adjust security information reporting rates. Suspicious network activity may include unusual traffic patterns, unusual authentication attempts, unusual transactions, or other network behaviors atypical of normal network operations.

Various embodiments may collect information about the availability of on-device security screening, network-based security screening, device characteristics presenting security risks and network traffic characteristics. This information is analyzed in order to determine whether the frequency with which the endpoint device provides security information reporting to the network server should be modified.

The polling frequency of endpoint devices may be set or adjusted in various ways. Some embodiments implement on-device adjustment of polling frequency by the endpoint device, thereby reducing the number of polling transmissions sent by an endpoint device to a server. Some embodiments set or adjust the polling frequency of endpoint devices on a server by modifying the frequency of pushed notifications/security report requests transmitted to endpoint devices.

In overview, the various embodiments include methods, and computing devices configured to perform the methods, of dynamically modifying the polling frequency of endpoint devices within an endpoint protection system. Various embodiments may include determining a risk factor for an endpoint device, by an endpoint device or a server of a network environment, based on various criteria described above, and modifying the polling frequency of the end point device. The endpoint device may then transmit polling messages to the network server according to the adjusted polling frequency (i.e., polling) to request security information.

In various embodiments, the endpoint device may self-regulate the frequency with which it polls the network server for security status report requests. In such embodiments, the detection of on-device security screening, network-network based security screening, suspicious/malicious device characteristics, and network traffic characteristics may be determined by the endpoint device itself.

In various embodiment methods for modifying polling frequency in an endpoint protection system within a communications network, an endpoint device may determine whether communication device endpoint protection is in active operation. Communication device endpoint protection may be real-time malware detection, device health monitoring, or another malicious or performance-degrading behavior detection application. The endpoint device may analyze the current status of such applications to ascertain whether the application is active or inactive. In some implementations, the endpoint device may determine whether communication device endpoint protection is enabled or disabled. Enabled applications may be considered to be active regardless of whether the application is currently performing tasks.

Once the endpoint device determines that communication device endpoint protection is active/enabled, the endpoint device may adjust a locally-stored polling frequency. The polling frequency may include a duration of time between transmissions of polling messages by a transceiver of the endpoint device to the network server (i.e., EPCC). The polling messages may contain requests for security information such as network security analysis information, as well as EPCC-originated security status report requests. Such polling messages may provide an open invitation for the network server to push updates to security information and security status report requests to the endpoint device as soon as such updates and requests are available.

In various embodiments, each endpoint device within the network may poll the network server at intervals according to its own specific polling frequency. Each endpoint device may receive security information from the network server (i.e., EPCC) as the information becomes available. Such information may include the active/enabled state of network-based security measures, external information obtained by the EPCC about endpoint device characteristics that present security risks, suspicious network activity observed by the network server or other network components, and security status report requests. The endpoint device may analyze the security information and adjust the polling frequency accordingly. For example, the endpoint device may increase the frequency of polling message transmission (such as by reducing the time interval between polling messages) if the endpoint device determines that there is no active network-based security measures, the endpoint device has characteristics susceptible to exploitation by malicious software, and/or the network server has observed malicious traffic associated with a website recently visited by an application executing on the endpoint device. Conversely, the endpoint device may decrease the frequency of polling message transmission if the security information indicates that network-based security measures are actively operating, and no suspicious characteristics or network activity are detected. Thus, each endpoint device within the network may individually adjust its own polling frequency based on the security risk the endpoint may pose to itself and the network as a whole.

In response to receiving security status report requests pushed by the network server (i.e., EPCC), the endpoint device may generate security status reports. Such reports may be transmitted to the network server or other network component according to the network infrastructure.

In some embodiments, the network server may regulate the frequency with which each endpoint device polls the network server for security information requests. In such embodiments, the detection of on-device security screening, network-based security screening, and suspicious/malicious device characteristics may be determined by the network server and communicated to the endpoint device.

Various embodiments include a network server (i.e., EPCC) that actively communicates security information to endpoint devices in order to improve endpoint protection. In addition to, or as an alternative to, the endpoint device assessment, the network server may determine whether an endpoint device is running communication device endpoint protection on the endpoint device. The server may make this determination based, at least in part, on a received endpoint device security status report. The network server may also monitor network-based security information to determine whether the endpoint device is protected by network-based security mechanisms. The network server (i.e., EPCC) may then calculate a recommended polling frequency for the endpoint device adjusting a polling frequency associated with the endpoint device based, at least in part, on whether the endpoint device is running communication device endpoint protection. The network server may then transmit the adjusted polling frequency to the endpoint device.

In various embodiments, the network server (i.e., EPCC) may monitor network security in order to provide information to endpoint devices within the endpoint protection system. The network server may determine whether network-based security schemes are active/enabled and operating properly. The network server may observe and analyze network traffic to detect potentially threatening behavior such as malicious websites, rogue access points, man-in-the middle attacks, (D)DoS attacks, and the like. The network server may receive information from external sources or through its own behavior analysis methods, identifying characteristics of specific make/model/type of endpoint device that may be exploitable by malicious software or otherwise present a security risk. This security information may be pushed to endpoint devices in the network as the information becomes available.

In order to assess the security risk posed by endpoint devices within the network, the network server (i.e., EPCC) may periodically push security status report requests to the endpoint devices. The network server may collect security status report responses and analyze the response in order to identify compromised endpoint devices.

Various embodiments may include components configured to adjust the frequency for endpoint device-originated polling in an endpoint protection system that requires EPCC-initiated push messaging for security status reports.

Various embodiments may include components configured to enable endpoint devices with active on-device security mechanisms (e.g. device health monitoring, runtime malware detection) to use a coarser polling frequency than is permitted for devices without such features.

Various embodiments may include components configured to adjust the polling frequency implemented by endpoint devices based, at least in part, on the availability of network-based security measures, on-device anomaly detection, endpoint device characteristics, and network traffic characteristics.

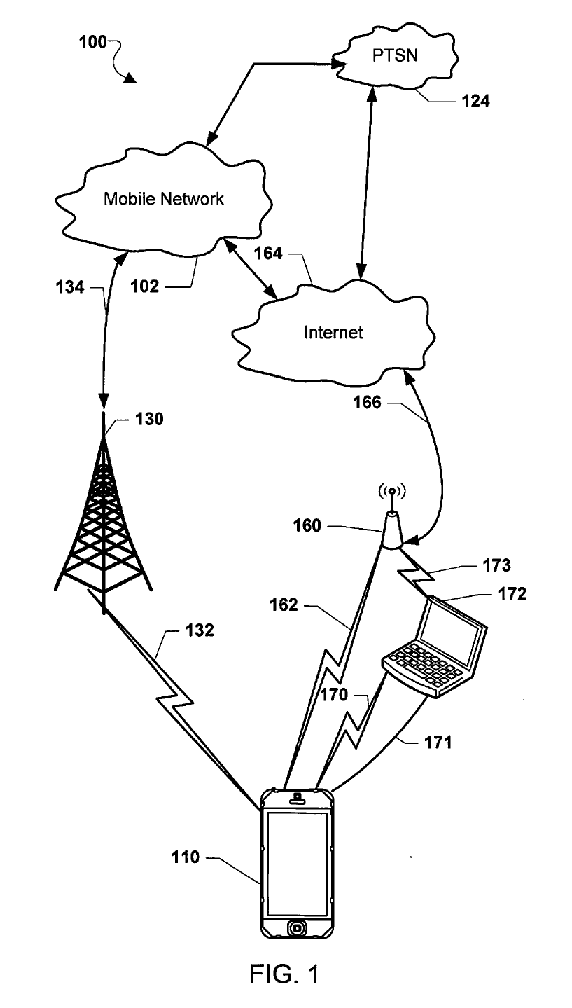

Various embodiments may be implemented within a variety of communications systems 100, an example of which is illustrated in FIG. 1. A mobile network 102 typically includes a plurality of cellular base stations (e.g., a first base station 130. The network 102 may also be referred to by those of skill in the art as access networks, radio access networks, base station subsystems (BSSs), Universal Mobile Telecommunications Systems (UMTS) Terrestrial Radio Access Networks (UTRANs), etc. The network 102 may use the same or different wireless interface technologies and/or physical layers. In an embodiment, the base station 130 may be controlled by one or more base station controllers (BSCs). Alternate network configurations may also be used and the embodiments are not limited to the configuration illustrated.

A first communications device 110 may be in communications with the mobile network 102 through a cellular connection 132 to the first base station 130. The first base station 130 may be in communications with the mobile network 102 over a wired connection 134.

The cellular connection 132 may be made through two-way wireless communications links, such as Global System for Mobile Communications (GSM), UMTS (e.g., Long Term Evolution (LTE)), Frequency Division Multiple Access (FDMA), Time Division Multiple Access (TDMA), Code Division Multiple Access (CDMA) (e.g., CDMA 1100 1×), Wideband CDMA (WCDMA), Personal Communications (PCS), Third Generation (3G), Fourth Generation (4G), Fifth Generation (5G), or other mobile communications technologies. In various embodiments, the communications device 110 may access network 102 after camping on cells managed by the base station 130.

The network 102 may be interconnected by a public switched telephone network (PSTN) 124 and/or the Internet 164, across which the network 102 may route various incoming and outgoing communications to/from the communications device 110.

In some embodiments, the first communications device 110 may establish a wireless connection 162 with a wireless access point 160, such as over a WLAN connection (e.g., a Wi-Fi connection). In some embodiments, the first communications device 110 may establish a wireless connection 170 (e.g., a personal area network connection, such as a Bluetooth connection) and/or wired connection 171 (e.g., a USB connection) with a second communications device 172. The second communications device 172 may be configured to establish a wireless connection 173 with the wireless access point 160, such as over a WLAN connection (e.g., a Wi-Fi connection). The wireless access point 160 may be configured to connect to the Internet 164 or another network over the wired connection 166, such as via one or more modem and router. Incoming and outgoing communications may be routed across the Internet 164 to/from the communications device 110 via the connections 162, 170, and/or 171. In some embodiments, the access point 160 may be configured to run NAT services mapping local network addresses of the first communications device 110 and the second communications device 172 to a public IP address and port prior to routing respective data flows to Internet 164.

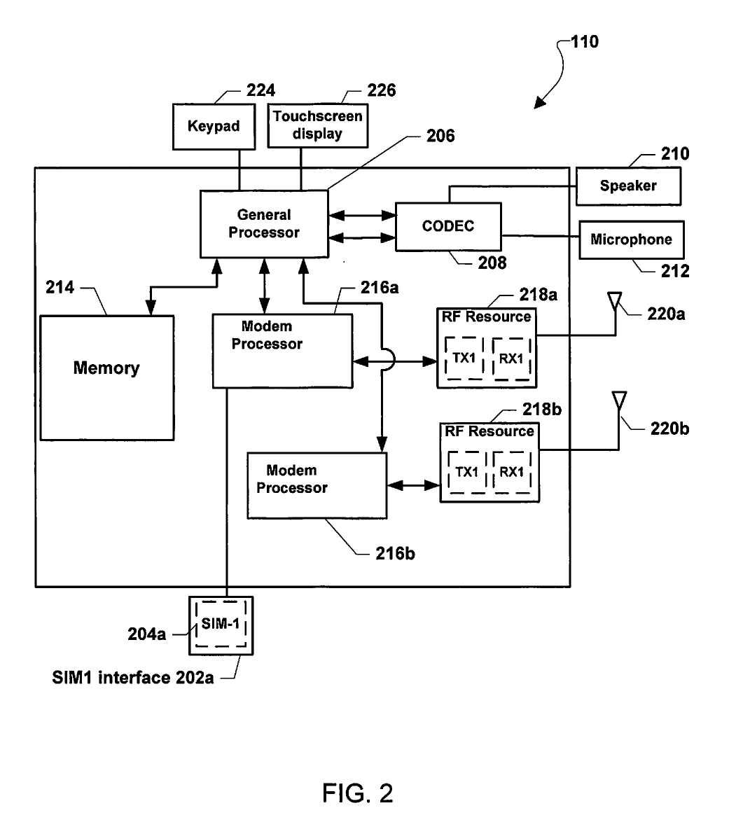

FIG. 2 is a functional block diagram of an example communications device 110 that is suitable for implementing various embodiments. With reference to FIGS. 1 and 2, the communications device 110 may include a first subscriber identity module (SIM) interface 202a, which may receive a first identity module SIM 204a that is associated with a first subscription.

A SIM, in various embodiments, may be a Universal Integrated Circuit Card (UICC) that is configured with SIM and/or Universal SIM (USIM) applications, enabling access to, for example, GSM, and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. Each SIM card may have a CPU, ROM, RAM, EEPROM, and I/O circuits.

A SIM used in various embodiments may contain user account information, an international mobile subscriber identity (IMSI), a set of SIM application toolkit (SAT) commands, and storage space for phone book contacts. A SIM card may further store home identifiers (e.g., a System Identification Number (SID)/Network Identification Number (NID) pair, a Home PLMN (HPLMN) code, etc.) to indicate the SIM card network operator provider. An Integrated Circuit Card Identity (ICCID) SIM serial number is printed on the SIM card for identification. However, a SIM may be implemented within a portion of memory of the communications device 110 (e.g., memory 214), and thus need not be a separate or removable circuit, chip or card.

The communications device 110 may include at least one controller, such as a general processor 206, which may be coupled to a coder/decoder (CODEC) 208. The CODEC 208 may in turn be coupled to a speaker 210 and a microphone 212. The general processor 206 may also be coupled to the memory 214. The memory 214 may be a non-transitory computer readable storage medium that stores processor-executable instructions. For example, the instructions may include routing communications data though a corresponding radio frequency (RF) resource chain.

The memory 214 may store an operating system (OS), as well as user application software and executable instructions. The memory 214 may also store application data, such as an array data structure.

The general processor 206 and the memory 214 may each be coupled to at least two modem processors 216a and 216b. A first RF resource chain may include the first modem processor 216a, which may perform baseband/modem functions for communicating with/controlling an interface technology, and may include one or more amplifiers and radios, referred to generally herein as RF resources (e.g., RF resources 218a). The SIM 204a in the communications device 110 may use the first RF resource chain. The RF resource 218a may be coupled to antenna 220a and may perform transmit/receive functions for the wireless services, such as services associated with SIM 204a, of the communications device 110. The RF resource 218a may provide separate transmit and receive functionality, or may include a transceiver that combines transmitter and receiver functions. A second RF resource chain may include the second modem processor 216b, which may perform baseband/modem functions for communicating with/controlling an interface technology, and may include one or more amplifiers and radios, referred to generally herein as RF resources (e.g., RF resources 218b). The RF resource 218b may be coupled to antenna 220b and may perform transmit/receive functions for the wireless services of the communications device 110. The RF resource 218b may provide separate transmit and receive functionality, or may include a transceiver that combines transmitter and receiver functions.

In various embodiments, the first RF resource chain including the first modem processor 216a and the second RF resource chain including the second modem processor 216b may be associated with different interface technologies. For example, one RF resource chain may be associated with a cellular air interface technology and the other RF resource chain may be associated with a WLAN technology. As another example, one RF resource chain may be associated with a cellular air interface technology and the other RF resource chain may be associated with a personal area network (PAN) technology. As another example, one RF resource chain may be associated with a PAN technology and the other RF resource chain may be associated with a WLAN technology. As another example, one RF resource chain may be associated with a cellular air interface technology and the other RF resource chain may be associated with a satellite interface technology. As another example, one RF resource chain may be associated with a WLAN technology and the other RF resource chain may be associated with a satellite air interface technology. Other combinations of different interface technologies, including wired and wireless combinations, may be substituted in the various embodiments, and cellular air interface technologies, WLAN technologies, satellite interface technologies, and PAN technologies are merely used as examples to illustrate aspects of the various embodiments.

In some embodiments, the general processor 206, the memory 214, the modem processors 216a, 216b, and the RF resources 218a, 218b may be included in the communications device 110 as a system-on-chip. In some embodiments, the SIM 204a and the corresponding interface 202a may be external to the system-on-chip. Further, various input and output devices may be coupled to components on the system-on-chip, such as interfaces or controllers. Example user input components suitable for use in the communications device 110 may include, but are not limited to, a keypad 224, a touchscreen display 226, and the microphone 212.

In some embodiments, the keypad 224, the touchscreen display 226, the microphone 212, or a combination thereof, may perform the function of receiving a request to initiate an outgoing call. For example, the touchscreen display 226 may receive a selection of a contact from a contact list or receive a telephone number. In another example, either or both of the touchscreen display 226 and the microphone 212 may perform the function of receiving a request to initiate an outgoing call. As another example, the request to initiate the outgoing call may be a in the form of a voice command received via the microphone 212. Interfaces may be provided between the various software modules and functions in the communications device 110 to enable communications between them. Inputs to the keypad 224, touchscreen display 226, and the microphone 212 discussed above are merely provided as examples of types of inputs that may initiate an outgoing call and/or initiate other actions on the communications device 110. Any other type of input or combinations of inputs may be used in various embodiments to initiate an outgoing call and/or initiate other actions on the communications device 110.

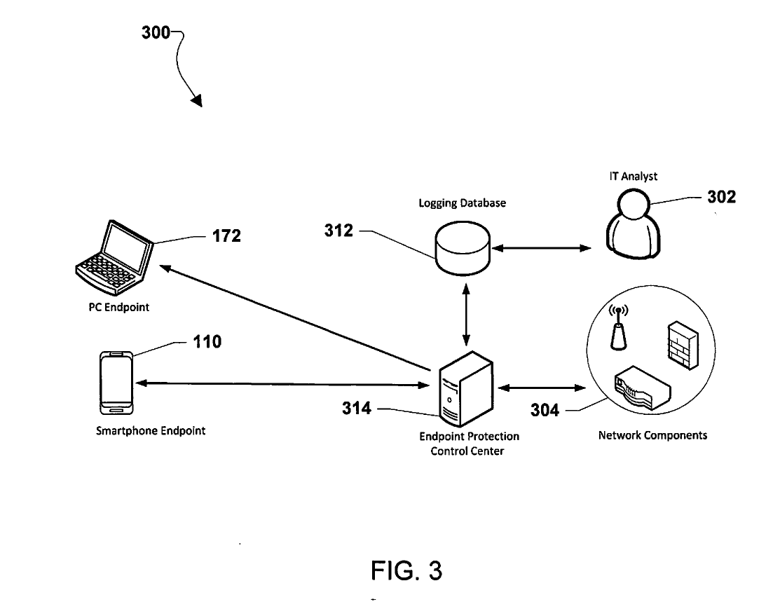

FIG. 3 is a network diagram illustrating interactions between an endpoint device (e.g., the communications device 110 as described with reference to FIGS. 1-3) and a network 300 implementing endpoint protection according to various embodiments. One or more communication devices 110, 172 may establish a network connection of a WLAN interface technology with a network server 314 (i.e., EPCC) running network address translation (NAT) services. The network server 314 may be in communication with a logging database 312 to enable long-term tracking of security threats. The network may contain a variety of additional network components 304 such as access points (e.g., routers), firewalls, switches, and other network infrastructure.

Various embodiments may include network-based security measures, in which network traffic sourced from an IP address associated with an endpoint device, which exhibits abnormal traffic patterns (e.g. abnormal or atypical packet size, inter-arrival times, etc.), may be detected in a router of the network 300. The network component 304 detecting the unusual network traffic may report the activity to the network server 314. The network server 314 may then transmit a security status report request to the endpoint device 110, such as by a push message. In order to detect the push message, the impacted endpoint device 110 must poll the network server 314 with some frequency. Polling frequency is relevant, as some messaging protocols (e.g., HTTP 1.1-based protocols) may not support timely server-originated pushes if the endpoint device's polling frequency is below a threshold. However, a lack of push messages from the network server 314 may be less important to endpoint devices 110, 172 with communication device endpoint protection schemes that may automatically transmit a security status report to the network server 314 upon the detection of an anomaly event without waiting for a push message requesting the report.

An endpoint device running communication device endpoint protection (such as endpoint device 172) may be able to use a coarser (i.e., less frequent) polling strategy than an endpoint device that does not run on-device anomaly detection, such as endpoint device 110. If the endpoint device 172 running communication device endpoint protection is compromised, such as by a root kit included in a downloaded software application, the communication device endpoint protection mechanism may be able to detect the compromise within “d” milliseconds. An exemplary calculation of the amount of time from the compromise of the endpoint device 172 to the receipt of an associated security status report by the network server 314 from the impacted endpoint device 172 may be represented as:

$${D}_{tot} \leq d + {D}_{OTA} = d + {\sum }_{i = 1}^{M} {( Cp )}^{i - 1} pNT + ( {Add}_{m} ) MNT \qquad ( 1 )$$

where N is the number of automatic repeat requests [ARQ phases (typically 4)] assuming endpoint device 172 communication via a cellular system using an N-phase hybrid ARQ method for reliability (3G and 4G), T is the physical layer frame duration (2 ms for UMTS-based systems), f is the probability of ARQ acknowledgment error (may be assumed to be fixed), M is the maximum number of retransmissions, C is a fixed constant related to the reduction in frame error with each successive retransmission. Further,

$${Add}_{m} = {\sum }_{i = 0}^{M - 1} {fp ( Cp )}^{i} {( 1 - f )}^{i} + {p ( Cp )}^{M} {( 1 - f )}^{M} \qquad ( 2 )$$

However, if an endpoint device 110 that is not running communication device endpoint protection, network-based security measures may be assumed to detect the endpoint device 110 compromise after a period time that may be represented by a stochastic time variable “tᵣₒₒₜ”. For a polling duration “p” and a one-way delay of “D_{OTA}” as defined in Equation (2), then the delay from occurrence of the anomaly event to receipt of the associated security status report by the network server 314 may be represented by the function:

Dₜₒₜ_{_}_{nsec}≦tᵣₒₒₜ+tₚₒₗₗ+3D_{OTA}+D_{dev}_{_}_{proc}+D_{EPCC} (3)

where “tᵣₒₒₜ” is the time needed for a post compromise anomaly event that is detectable by the network-based security measures to occur; “tₚₒₗₗ” is the duration of time between polling messages and thus is the maximum amount of time between detection and receipt by the network server 314 of the security status report (which is bounded by tₚₒₗₗ but on average may be assumed to be uniformly distributed within the interval [0, tₚₒₗₗ]). The term “D_{OTA}” is the over-the-air delay of three messages to be sent: (1) the polling message from the compromised endpoint device 110, (2) the status report request from the network server 314, and (3) the actual report sent from the device. The fourth term, D_{dev}_{_}_{proc}, accounts for endpoint device 110 parsing and processing delay for the push message (usually less than 200 ms). The term “D_{EPCC}” is a parsing and processing delay representing processing time at the network server 314 for the polling message (assumed to be 100 ms).

Therefore, the detection of endpoint device-based anomaly events by communication device endpoint protection schemes may result in faster alerting of the endpoint protection system than detection and alerting resulting from network-based security measures. Endpoint devices 172 running communication device endpoint protection may have reduced need of network server polling, because the endpoint device is likely to detect and report any local anomaly events well in advance of network-based detection schemes. The network server 314 may monitor and analyze network infrastructure health and endpoint device security, and may communicate this information via push messages to endpoint devices 110, 172, thereby enabling the endpoint devices to dynamically determine a polling frequency based on their own endpoint protection methods, as well as the current state of network security risk.

The network server 314 (i.e., EPCC) may transmit security status reports regarding detected anomaly events, along with network observations and analysis to the logging database 312. The information stored in a logging database 312 may be used by the network server 314 in identifying patterns in network traffic, anomalous behavior, and the like. Similarly, logging of anomaly event related security status reports may enable IT analysts 302 to ascertain the nature of security risks within the network infrastructure.

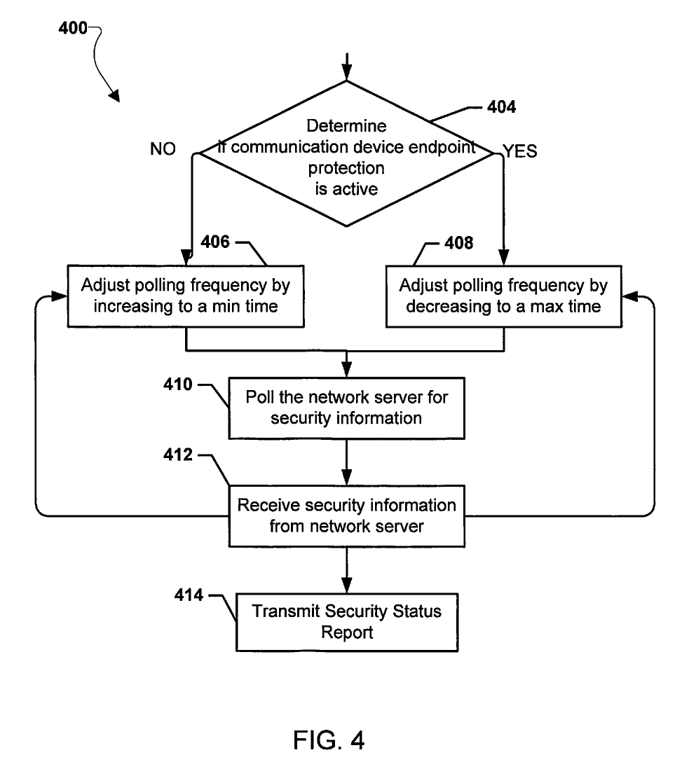

FIG. 4 illustrates a method 400 for modifying polling frequency in an endpoint protection system according to various embodiments. With reference to FIGS. 1-4, the method 400 may be implemented with a processor (e.g., the general processor 206, the modem processors 216a, 216b, a separate controller, and/or the like) of an endpoint device (e.g., the communications device 110 described with reference to FIGS. 1-2). For example, the method 400 may be implemented by a processor (e.g., the general processor 206, the modem processors 216a, 216b, a separate controller, and/or the like) of an endpoint device (e.g., the communications device 110 described with reference to FIGS. 1 and 2).

In determination block 404, the processor (e.g., processor 206) of an endpoint device (e.g., communications device 110) may determine whether the endpoint device is running communication device endpoint protection. The endpoint device may check the status of malware detection applications, runtime malware detection, and device health applications to determine whether any such mechanisms are enabled and/or active on the endpoint device. Communication device endpoint protection that is inoperative or disabled may not return a positive result, because applications in a disabled state do not provide the endpoint device with anomaly detection or protection.

If the endpoint device determines that one or more communication device endpoint protection applications are active (i.e., determination block 404=“Yes”), the processor (e.g., processor 206) may decrease the polling frequency currently retained in a memory of the endpoint device in block 408. That is, the processor may increment the duration of time between subsequent transmissions of polling messages to the network server (e.g., network server 314) by the endpoint device. In various embodiments, a maximum threshold or upper limit may be placed on the time interval to prevent the polling frequency from increasing indefinitely. Therefore, the value of the polling frequency may move between an average time, the maximum time, and a minimum time as current security risk conditions change.

In response to determining that one or more communication device endpoint protection applications are not active (i.e., determination block 404=“No”), the processor (e.g., processor 206) may increase the polling frequency currently retained in a memory of the endpoint device in block 406.

In block 410, the processor (e.g., processor 206) of the endpoint device (e.g., communications device 110) may poll the network server (e.g., network server 314) for security information. The endpoint device may send a polling message to the network server 314 using a transceiver or network interface of the endpoint device. The polling message may be a transmission requesting that the network server 314 push data regarding certain types of security information to the endpoint device when the data is available. The security information requested may not be available to the network server at the time the polling message is sent. Thus, the polling message may expire after an interval. A new message may be sent in order to avoid time out and the resulting lapses in security information requests active on the network server 314.

If the endpoint device is running an active communication device endpoint protection application, then the endpoint device may not be as reliant on security information provided by the network server. This is because the communication device endpoint protection may be more efficient at detecting and/or preventing malicious or performance degrading behaviors directly impacting the endpoint device.

In block 412, the processor (e.g., processor 206) of the endpoint device (e.g., communications device 110) may receive security information from the network server 314 at such time as the network server has information to share. Security information may include one or more of a request from the server for a security status report from the endpoint device, an instruction to the endpoint device to adjust the endpoint device's polling frequency, as well as optional information about suspicious network activity, suspicious endpoint device characteristics, and/or the status of network-based security measures. The network server 314 may push this information to the endpoint device when the network server requires action from the endpoint device.

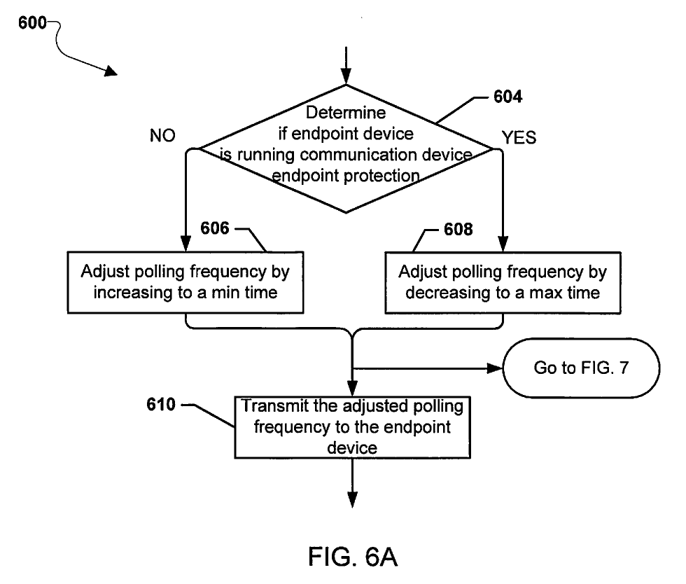

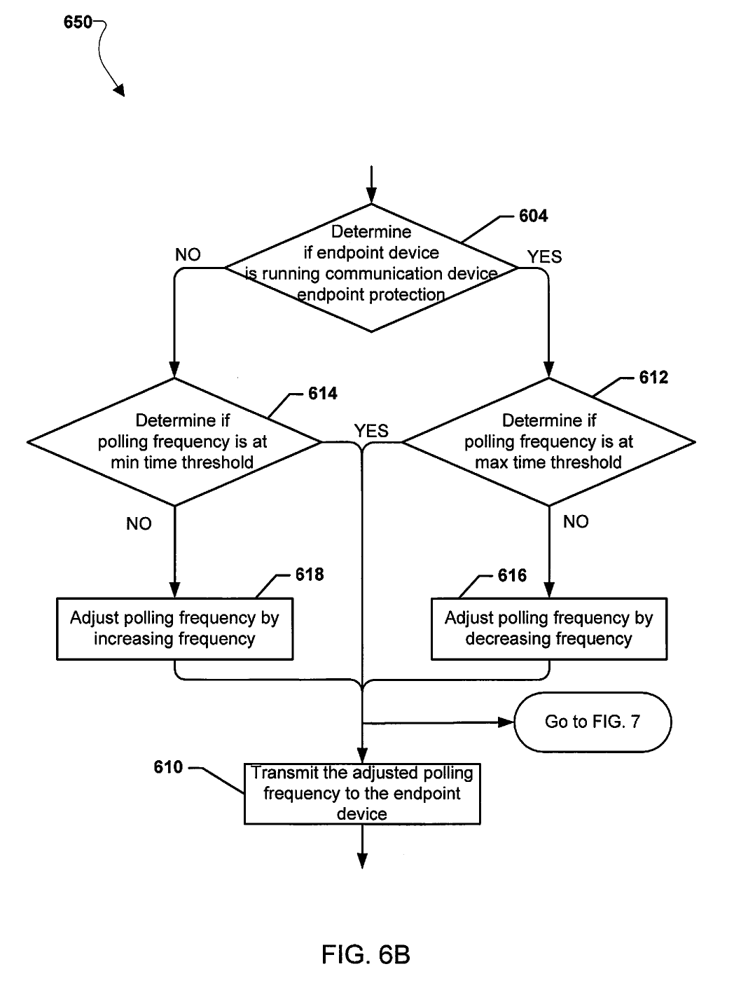

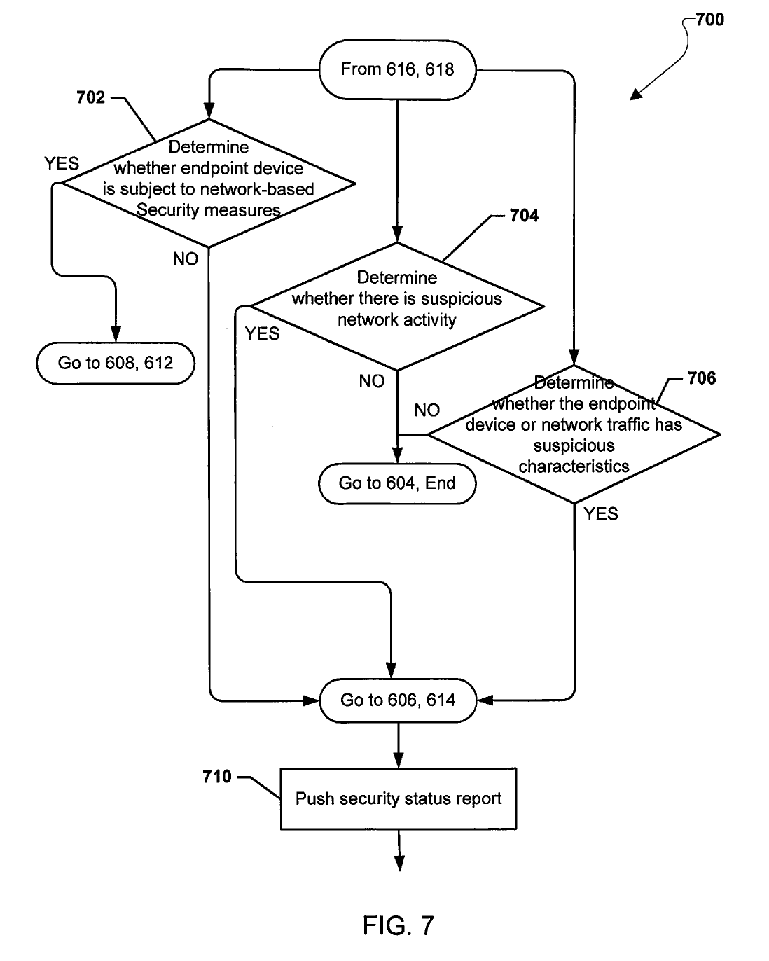

Security status report requests may be pushed from the network server 314 to the endpoint device when the network server 314 has determined that the endpoint device may be at risk. As is discussed in greater detail with reference to FIGS. 6A, 6B, and 7, the network server may, through observation and analysis of the network, determine that the endpoint device poses a security risk. The network server 314 may request security status reports related to endpoint device operating system status and software application activities. In block 414, the processor (e.g., processor 206) of an endpoint device (e.g., communications device 110) may transmit one or more security status reports to the network server 314 in response to the pushed security status report request. The endpoint device may then begin a new cycle of polling the network server for security information, such as in block 410.

In some embodiments, the network server 314 may determine, based on analysis of available information, that the endpoint device may poll more or less frequently. As discussed in greater detail with reference to FIGS. 6A, 6B and 7, the network server 314 may adjust a polling frequency associated with the endpoint device and stored on the server, and may transmit the adjusted polling frequency to the endpoint device. If an instruction to modify the polling frequency is included in the security information, then the endpoint device may increase, in block 406, or decrease, in block 408, the polling frequency according to the received instruction.

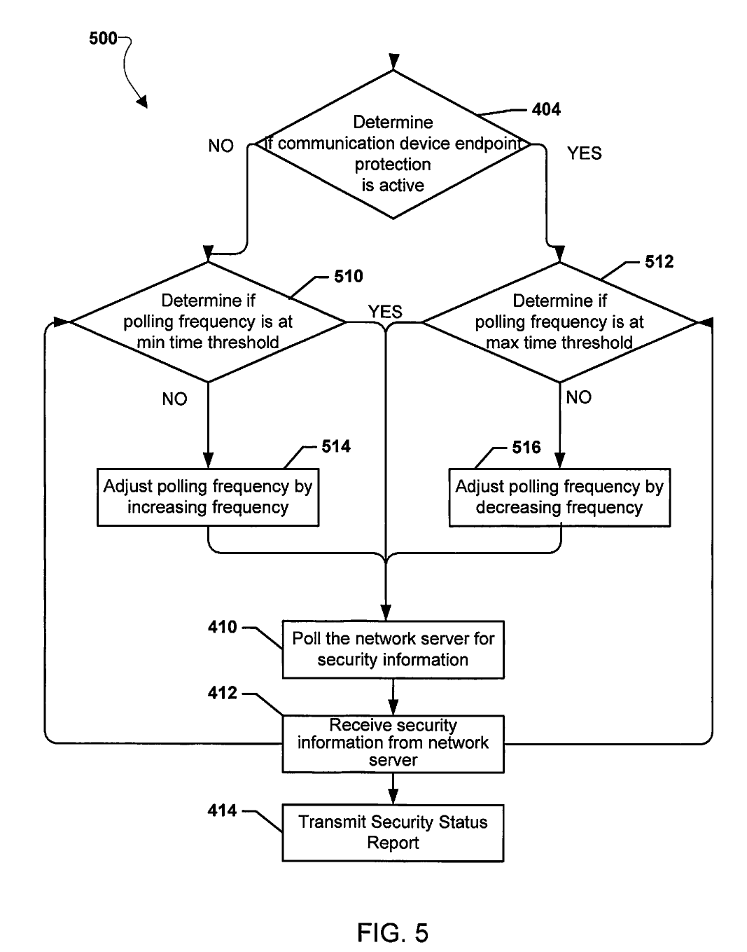

FIG. 5 illustrates a method 500 for modifying polling frequency in an endpoint protection system according to various embodiments. With reference to FIGS. 1-5, the method 500 may be implemented with a processor (e.g., the general processor 206, the modem processors 216a, 216b, a separate controller, and/or the like) of an endpoint device (e.g., the communications device 110 described with reference to FIGS. 1-2). For example, the method 500 may be implemented by a processor (e.g., the general processor 206, the modem processors 216a, 216b, a separate controller, and/or the like) of an endpoint device (e.g., the communications device 110 described with reference to FIGS. 1 and 2).

In determination block 404, the processor (e.g., processor 206) of an endpoint device (e.g., communications device 110) may determine whether the endpoint device is running communication device endpoint protection. This determination may commence in the manner described with reference to FIG. 4.

In response to determining that one or more communication device endpoint protection applications are active (i.e., determination block 404=“Yes”), the processor (e.g., processor 206) may determine whether the polling frequency is at a maximum time threshold in determination block 512. The processor may compare the current polling frequency to a threshold limit, past which the polling frequency should not be decreased.

In response to determining that the polling frequency is not at the maximum time threshold, (i.e., determination block 512=“No”), the processor may decrease the frequency of polling by incrementing the time between subsequent polling message transmissions in block 516. Modifications to the polling frequency may be made in set increments of time, or may be dynamic.

In response to determining that the polling frequency is already set to the maximum time threshold (i.e., block 512=“Yes”), the processor may poll the network server security for information in block 410. Polling may commence in the manner described with reference to FIG. 4.

In response to determining that one or more communication device endpoint protection applications are not active (i.e., determination block 404=“No”), the processor (e.g., processor 206) may determine whether the polling frequency is at a minimum time threshold in block determination 510. The processor may compare the current polling frequency to a minimum time threshold representing the smallest time interval permitted between transmission of polling messages.

In response to determining that the polling frequency is not set to the minimum time threshold (i.e., determination block 510=“No”), the processor may increase the polling frequency by reducing the time interval between polling message transmissions in block 514.

In response to determining that the polling frequency is already set to the minimum time threshold (i.e., determination block 510=“Yes”), the processor may poll the network server for security information in block 410. Polling may commence in the manner described with reference to FIG. 4.

In block 412, the processor (e.g., processor 206) of the endpoint device (e.g., communications device 110) may receive the requested security information from the network server (e.g., network server 314). The receipt of security information may commence in the manner described with reference to FIG. 4.

In block 414, the processor (e.g., processor 206) of the endpoint device (e.g., communications device 110) may transmit a security status report to the network server (e.g., network server 314). Transmission of the security status report may commence in the manner described with reference to FIG. 4.

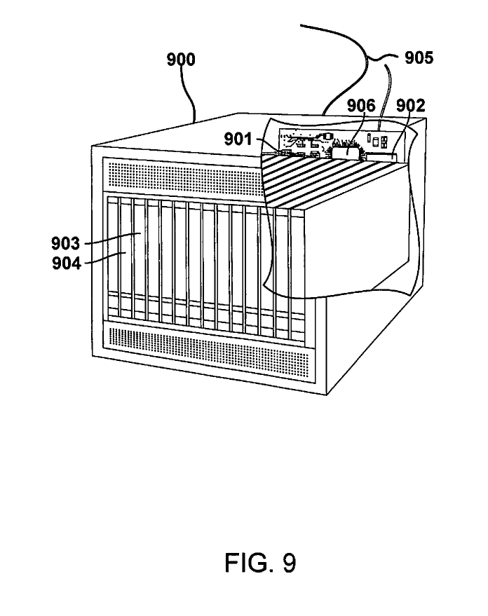

FIGS. 6A-6B illustrate methods 600, 650 for modifying polling frequency in an endpoint protection system according to various embodiments. With reference to FIGS. 1-6B and 9, the methods 600, 650 may be implemented with a processor (e.g., the processor 901) of a network server 314 (e.g., the server 900 described with reference to FIG. 9).

In determination block 604, the processor (e.g., processor 901) of a network server (e.g., server 314, 900) may determine whether the endpoint device is running communication device endpoint protection. The processor may access a local memory (e.g., local memory 902, 903) or obtain from the logging database 312, a security status report associated with an endpoint device (e.g., communications device 110). The network server, acting as an EPCC, may analyze the security status report to determine whether the endpoint device is actively running local/on-device anomaly detection.

In response to determining that one or more communication device endpoint protection applications are active on the endpoint device (i.e., determination block 604=“Yes”), the processor (e.g., processor 901) may decrease the polling frequency associated with the endpoint device to a maximum time interval between polling message transmission in block 608.

In response to determining that one or more communication device endpoint protection applications are not active (i.e., determination block 604=“No”), the processor (e.g., processor 206) may increase the polling frequency by decreasing the amount of time between subsequent polling message transmissions in block 606.

In some embodiments, the network server 314 may store polling frequencies associated with each endpoint device currently present in the network. In some embodiments, the network device may not store specific polling frequencies, but may instead determine increments and decrements and send the net adjustment to an endpoint device in the form of an instruction for the endpoint device to modify its polling frequency. Thus, either a polling frequency specific to the endpoint device may be modified and transmitted to the endpoint device, or a net adjustment may be calculated and transmitted to the endpoint device.

FIG. 6B illustrates a method 650 (FIG. 6B) that may be performed by the processor (e.g., processor 901) of the network server 314 (e.g., server 900) in a manner similar to the method 600 (FIG. 6A). However, the method 650 may enable granular modification of polling frequency by adjusting maximum and minimum polling frequency within a range of maximum and minimum time intervals. Adjustment of polling frequencies within time ranges is also discussed in detail with reference to FIG. 5, which illustrates an endpoint device method for polling frequency modification.

In determination block 604, the processor (e.g., processor 901) of a network server (e.g., server 900) may determine whether the endpoint device is running communication device endpoint protection. The network server may do so by analyzing previously received security status reports associated with the endpoint device. This determination may commence in the manner described with reference to FIG. 6A.

In response to determining that communication device endpoint protection applications are active on the endpoint device (i.e., determination block 604=“Yes”), the processor (e.g., processor 206) may determine if the polling frequency is at a maximum time threshold in determination block 612. The processor may compare a current or average polling frequency to a threshold limit, past which the polling frequency should not be decreased.

In response to determining that the polling frequency is not at the maximum time threshold, (i.e., determination block 612=“No”), the processor may decrease the frequency of polling by incrementing the time between subsequent polling message transmissions in block 616.

In response to determining that communication device endpoint protection applications are not active on the endpoint device (i.e., determination block 604=“No”), the processor (e.g., processor 901) may determine whether the polling frequency is at a minimum time threshold determination block 614. The processor may compare the current or average polling frequency to a minimum time threshold representing the smallest time interval permitted between transmission of polling messages.

In response to determining that the polling frequency is not set to the minimum time threshold (i.e., determination block 614=“No”), the processor may increase the polling frequency by reducing the time interval between polling message transmissions in block 618.

In response to determining that the polling frequency is already set to the maximum time threshold (i.e., determination block 612=“Yes”), or following adjustments to the polling frequency in either blocks 616 or 618, the polling frequency is already set to the minimum time threshold (i.e., determination block 614=“Yes”), the processor may execute the method 700 described with reference to FIG. 7, and transmit the adjust polling frequency to the endpoint device in the form of an instruction to modify the polling frequency in block 610. Transmission of the adjusted polling frequency may commence in the manner described with reference to FIG. 4.

FIG. 7 illustrates a method 700 for modifying polling frequency in an endpoint protection system according to various embodiments. With reference to FIGS. 1-7 and 9, the method 700 may be implemented with a processor (e.g., the processor 901) of a network server 314 (e.g., the server 900 described with reference to FIG. 9). In method 700, the network server 314 may detect and analyze network based activity and security factors in order to determine whether the granularity of endpoint device polling frequencies should be modified.

In determination block 702, the processor (e.g., processor 901) of a network server (e.g., server 314, 900) may determine whether the endpoint device is subject to network-based security measures. The network server 314 may review configuration information and/or rule sets for any network-based security measure. Such schemes may include network-based malware detection, traffic analyzers, and the like.

In response to determining that network-based security measures are active and covers the pertinent endpoint device (i.e., determination block 702=“Yes”), the processor may perform the operations in blocks 608 of method 600 or 612 of method 650 as described with reference FIGS. 6A and 6B. That is, the processor may decrease the frequency of polling messages by adjusting the polling frequency.

In response to determining that there is no active network-based security measures operating on the network, or response to determining that the specific endpoint device is not covered by active network-based security measures (i.e., determination block 702=“No”), the processor may perform the operations in block 606 of method 600 or determination block 614 of method 650 as described with reference to FIGS. 6A and 6B. That is, the processor may increase the polling frequency by decreasing the time interval between polling message transmissions. Thus, the network server 314 may enable coarser polling by endpoint devices subject to network-based security measures.

In determination block 704, the processor (e.g., processor 901) of a network server (e.g., server 314, 900) may determine whether there is any ongoing or recent suspicious network activity. Suspicious network activity may include unusual traffic patterns, unusual authentication attempts, unusual transactions, or other network behaviors atypical of normal network operations. Determining whether suspicious network activity is present may require the network server 314, in its capacity as an EPCC, to analyze current and recent network data traffic. This may be an ongoing part of EPCC operations, or may be performed upon receiving alerts or notifications from external sources or other network components.

In response to determining that there is suspicious network activity (i.e., determination block 704=“Yes”), the processor may perform the operations in block 606 of method 600 or block 614 of method 650 as described with reference to FIGS. 6A and 6B. Thus, the network server 314 may adjust the polling frequency by increasing the frequency of polling (i.e., decreasing the time interval between polling).

In response to determining that there is not any suspicious network activity (i.e., determination block 704=“No”), the processor may perform the operations in block 604 as described with reference to FIGS. 6A and 6B, or may end the operation. Thus, the network server 314 may return to the beginning and begin the polling frequency modification method again, or may simply terminate the current operation. This is because the lack of suspicious activity may not warrant a reduction in polling frequency, as no increase in security is assumed by the lack of suspicious network activity. Rather, the lack of suspicious activity merely indicates that there is no present network security risk indicated by suspicious activity.

In determination block 706, the processor (e.g., processor 901) of a network server (e.g., server 314, 900) may determine whether the endpoint device and/or network traffic has any suspicious characteristics. Suspicious characteristics may be device model/type known to be susceptible to exploits, unusual behaviors of applications executing on the endpoint device, suspicious websites visited by the endpoint device, and the like. The network server 314 may receive external information in the form of security updates, patches, malware notifications, exploit reports, and other alerts. The network server 314 may leverage such information in determining whether endpoint devices within the endpoint protection system (e.g., the network) may present security risks.

In response to determining that there is suspicious endpoint device characteristics and/or suspicious network traffic characteristics (i.e., determination block 706=“Yes”), the processor may perform the operations in block 606 of the method 600 or block 614 of the method 650 as described with reference to FIGS. 6A and 6B. Thus, the network server 314 may adjust the polling frequency by increasing the frequency of polling (i.e., decreasing the time interval between polling).

In response to determining that there is not any suspicious endpoint device characteristics or network traffic characteristics (i.e., determination block 706=“No”), the processor may perform the operations in block 604 as described with reference to FIGS. 6A and 6B, or may end the operation.

In block 710, the network server (e.g., server 900) may transmit or push a security status report request to the endpoint device. The push may be made in response to determining in one or more of determination blocks 702, 704, 706 that the endpoint device poses a security risk to the network. For example, in response to determining that that the endpoint device is not subject to network-based security measures (i.e., determination block 702=“NO”), that suspicious network activity is present (i.e., determination block 704=“YES”), or that the endpoint device has suspicious characteristics (i.e., determination block 706=“YES”), the network server 314 may wish to receive information from the endpoint device regarding the device's health in block 606 of the method 600 or block 614 of the method 650 as described with reference to FIGS. 6A and 6B. If an active polling message from the endpoint device is present on the network server 314, then the network server may push the security status report request to the endpoint device in block 710.

In various embodiments, the security status report request, the adjusted polling frequency, and some or all of the results of determination blocks 702, 704, and 706 may be transmitted to the endpoint device as security information. This security information may be pushed by the network server 314 as part of a response to an active polling message from the endpoint device.

A processor executing methods 600, 650 may then executing the method 700 in order to determine network-based security factors impacting polling frequency modification. In lieu of or after executing the operations of the method 700, the processor (e.g., processor 901) of the network server 314 may transmit the adjusted polling frequency to the endpoint device in block 610 of the method 600. The adjusted polling frequency may be transmitted as an instruction to modify the polling frequency in a specific manner. The adjusted polling frequency may be transmitted via a push message to the specific endpoint device to which the adjusted polling frequency applies. Upon receipt of the adjusted polling frequency, the instruction to modify the polling frequency may be stored locally on the endpoint device, and the endpoint device may update/adjust the polling frequency according to the instruction. (e.g., in block 412 of the method 400 described with reference to FIG. 4).

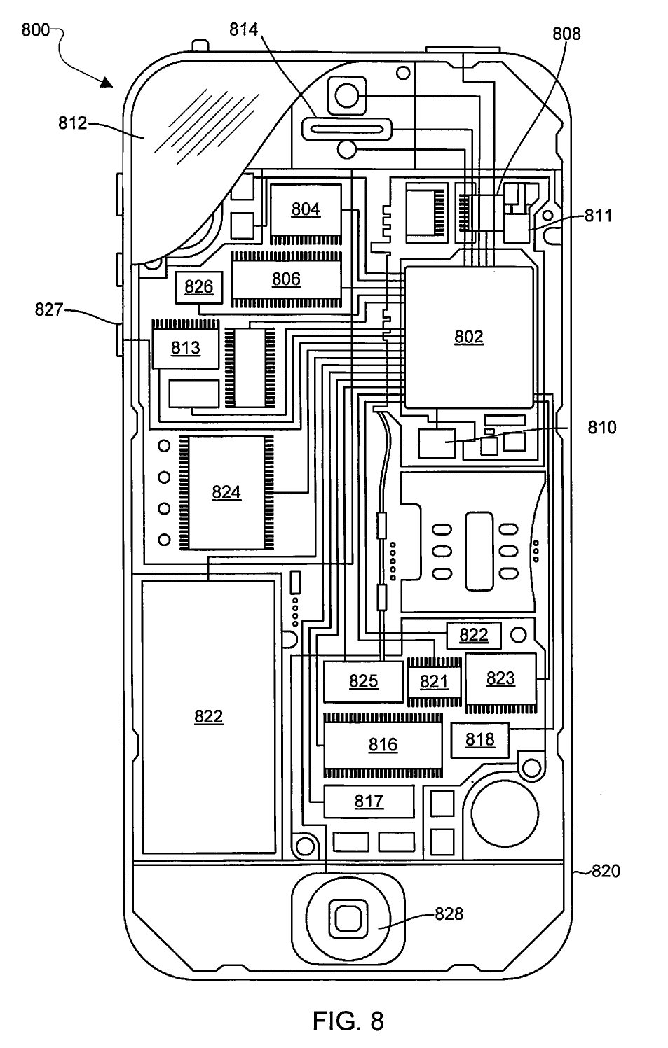

Various embodiments may be implemented in any of a variety of communications devices, an example on which (e.g., communications device 800) is illustrated in FIG. 8. With reference to FIGS. 1-8, the communications device 800 may be similar to the communications device 110 and may implement the method 500, the method 600, and/or the method 700 as described.

The communications device 800 may include a processor 802 coupled to a touchscreen controller 804 and an internal memory 806. The processor 802 may be one or more multi-core integrated circuits designated for general or specific processing tasks. The internal memory 806 may be volatile or non-volatile memory, and may also be secure and/or encrypted memory, or unsecure and/or unencrypted memory, or any combination thereof. The touchscreen controller 804 and the processor 802 may also be coupled to a touchscreen panel 812, such as a resistive-sensing touchscreen, capacitive-sensing touchscreen, infrared sensing touchscreen, etc. Additionally, the display of the communications device 800 need not have touch screen capability.

The communications device 800 may have one or more cellular network transceivers 808 coupled to the processor 802 and to one or more antennae 810 and configured for sending and receiving cellular communications. The transceiver 808 and the antenna 810 may be used with the circuitry mentioned herein to implement the methods of various embodiments. The communications device 800 may include one or more SIM cards (e.g., SIM 813) coupled to the transceiver 808 and/or the processor 802 and configured as described. The communications device 800 may include a cellular network wireless modem chip 817 coupled to the processor 802 that enables communications via a cellular network.

The communications device 800 may have one or more WLAN transceivers 816 (e.g., one or more Wi-Fi transceivers) coupled to the processor 802 and to one or more antennae 811 and configured for sending and receiving WLAN communications. The transceiver 816 and the antenna 811 may be used with the circuitry mentioned herein to implement the methods of various embodiments. The communications device 800 may include a WLAN wireless modem chip 818 coupled to the processor 802 that enables communications via a WLAN.

The communications device 800 may have one or more Bluetooth transceivers 821 coupled to the processor 802 and configured for sending and receiving Bluetooth communications. The Bluetooth transceiver 821 may be used with the circuitry mentioned herein to implement the methods of various embodiments. The communications device 800 may include a Bluetooth wireless modem chip 823 coupled to the processor 802 that enables communications via Bluetooth.

The communications device 800 may have one or more satellite transceivers 824 coupled to the processor 802 and to one or more antennae 825 and configured for sending and receiving Bluetooth communications. The transceiver 824 and the antenna 825 may be used with the circuitry mentioned herein to implement the methods of various embodiments. The communications device 800 may include a satellite wireless modem chip 826 coupled to the processor 802 that enables communications via satellite networks.

The communications device 800 may also include speakers 814 for providing audio outputs. The communications device 800 may also include a housing 820, constructed of a plastic, metal, or a combination of materials, for containing all or some of the components discussed herein. The communications device 800 may include a power source 822 coupled to the processor 802, such as a disposable or rechargeable battery. The rechargeable battery may also be coupled to the peripheral device connection port to receive a charging current from a source external to the communications device 800. The peripheral device connection port, such as a USB port, may be connected to the processor 802, and may be configured to established wired network connections via wired interface technologies and may be used with the circuitry mentioned herein to implement the methods of the various embodiments. The communications device 800 may also include a physical button 828 for receiving user inputs. The communications device 800 may also include a power button 827 for turning the communications device 800 on and off.

Portions of the implementation methods may be accomplished in a client-server architecture with some of the processing occurring in a server, which may be accessed by a mobile device processor while executing the implementation methods. Such implementations may be implemented on any of a variety of commercially available server devices, such as the server 900 illustrated in FIG. 9. Such a server 900 typically includes a processor 901 coupled to volatile memory 902 and a large capacity nonvolatile memory, such as a disk drive 903. The server 900 may also include a floppy disc drive, compact disc (CD) or digital versatile disc (DVD) disc drive 904 coupled to the processor 901. The server 900 may also include network access ports 906 coupled to the processor 901 for establishing data connections with a network 905, such as a local area network coupled to other broadcast system computers and servers.

The processors 802, 901 may be any programmable microprocessor, microcomputer or multiple processor chip or chips that can be configured by software instructions (applications) to perform a variety of functions, including the functions of the various implementations described below. In some mobile devices, multiple processors 802 may be provided, such as one processor dedicated to wireless communication functions and one processor dedicated to running other applications. Typically, software applications may be stored in the internal memory 806, 902, 903 before they are accessed and loaded into the processor 802, 901. The processor 802, 901 may include internal memory sufficient to store the application software instructions.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the various embodiments.

The hardware used to implement the various illustrative logics, logical blocks, modules, and circuits described in connection with the embodiments disclosed herein may be implemented or performed with a variety of processors. Examples of suitable processors include, for example, a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the various embodiments. Various modifications to these embodiments will be readily apparent to those skilled in the art, and the generic principles defined herein may be applied to some embodiments without departing from the scope of the claims. Thus, the present disclosure is not intended to be limited to the examples shown herein but is to be accorded the widest scope consistent with the following claims and the principles and novel features disclosed herein.

What is claimed is:

1. A method of modifying a polling frequency in an endpoint protection system within a communications network, comprising:
determining, by an endpoint device, whether communication device endpoint protection is active on the endpoint device; and
adjusting a polling frequency associated with the endpoint device based at least in part on whether communication device endpoint protection is active on the endpoint device.

2. The method of claim 1, further comprising:
polling, by a transceiver of the endpoint device, a network server for security information;
receiving the requested security information from the network server; and
adjusting the polling frequency of the endpoint device based at least in part on the received security information.

3. The method of claim 2, wherein the received security information includes information regarding whether the endpoint device is subject to network-based security measures, suspicious endpoint device characteristics, and suspicious network activity.

4. The method of claim 2, wherein the received security information includes a request for a security status report.

5. The method of claim 2, further comprising polling, by the endpoint device, the network server for updated security information at time intervals equal to the adjusted polling frequency.

6. The method of claim 2, further comprising:
receiving an instruction to modify the polling frequency from the network server; and
adjusting the polling frequency of the endpoint device based, at least in part, on the received instruction.

7. The method of claim 6, wherein the instruction is generated by the network server based, at least in part, on an analysis of the security information.

8. The method of claim 1, wherein the polling frequency is a frequency at which the endpoint device polls a network server for security information.

9. A method of modifying a polling frequency in an endpoint protection system within a communications network, comprising:
determining, by a server, based, at least in part, on a received endpoint device status report whether communication device endpoint protection is active on the endpoint device;
adjusting, by the server, a polling frequency associated with the endpoint device based at least in part on a result of determining whether communication device endpoint protection is on the endpoint device; and
transmitting the adjusted polling frequency from the server to the endpoint device.

10. The method of claim 9, further comprising:
determining, by the server, whether there is suspicious network activity; and
adjusting, by the server, the polling frequency associated with the endpoint device based at least in part on a result of determining whether there is suspicious network activity.

11. The method of claim 10, wherein determining whether there is suspicious network activity further comprises detecting, by the server, one or more of unusual network traffic patterns, unusual authentication transactions, or unusual authorization transactions.

12. The method of claim 9, wherein adjusting the polling frequency associated with the endpoint device comprises increasing the polling frequency in response to determining that communication device endpoint protection is not active on the endpoint device.

13. The method of claim 9, wherein adjusting the polling frequency comprises decreasing the polling frequency in response to determining that communication device endpoint protection is active on the endpoint device.

14. The method of claim 9, further comprising:
determining, by the server, whether there are any suspicious endpoint device characteristics; and
adjusting, by the server, the polling frequency based, at least in part, on a result of determining whether there are any suspicious endpoint device characteristics.

15. The method of claim 9, further comprising:
determining, by the server, whether the endpoint device is subject to network-based security measures; and
adjusting the polling frequency associated with the endpoint device based, at least in part, on a result of determining whether the endpoint device is subject to network-based security measures.

16. A computing device, comprising:
a transceiver configured to communicate via a communication network; and
a processor coupled to the transceiver and configured with processor-executable instructions to perform operations comprising:
determining whether communication device endpoint protection is active on the computing device; and
adjusting a polling frequency associated with the computing device based at least in part on whether communication device endpoint protection is active on the computing device.

17. The computing device of claim 16, wherein the processor is configured with processor-executable instructions to perform operations further comprising:
polling, by the transceiver, a network server for security information;
receiving the requested security information from the network server; and
adjusting the polling frequency of the computing device based at least in part on the received security information.

18. The computing device of claim 17, wherein the received security information includes information regarding whether the computing device is subject to network-based security measures, suspicious computing device characteristics, and suspicious network activity.

19. The computing device of claim 17, wherein the received security information includes a request for a security status report.

20. The computing device of claim 17, wherein the processor is configured with processor-executable instructions to perform operations further comprising polling the network server for updated security information at time intervals equal to the adjusted polling frequency.

21. The computing device of claim 17, wherein the processor is configured with processor-executable instructions to perform operations further comprising:
receiving an instruction to modify the polling frequency from the network server; and
adjusting the polling frequency of the computing device based, at least in part, on the received instruction.

22. The computing device of claim 21, wherein the instruction is generated by the network server based, at least in part, on an analysis of the security information.

23. The computing device of claim 16, wherein the polling frequency is a frequency at which the computing device polls a network server for security information.

24. A server, comprising:
a transceiver configured to communicate via a communication network; and
a processor coupled to the transceiver and configured with processor-executable instructions to perform operations comprising:
determining based, at least in part, on a received endpoint device status report whether communication device endpoint protection is active on the endpoint device;
adjusting a polling frequency associated with the endpoint device based at least in part on a result of determining whether communication device endpoint protection is on the endpoint device; and
transmitting the adjusted polling frequency from the server to the endpoint device.

25. The server of claim 24, wherein the processor is configured with processor-executable instructions to perform operations further comprising:
determining whether there is suspicious network activity; and
adjusting the polling frequency associated with the endpoint device based at least in part on a result of determining whether there is suspicious network activity.

26. The server of claim 25, wherein the processor is configured with processor-executable instructions to perform operations such that determining whether there is suspicious network activity further comprises detecting one or more of unusual network traffic patterns, unusual authentication transactions, or unusual authorization transactions.

27. The server of claim 24, wherein the processor is configured with processor-executable instructions to perform operations such that adjusting the polling frequency associated with the endpoint device comprises increasing the polling frequency in response to determining that communication device endpoint protection is not active on the endpoint device.

28. The server of claim 24, wherein the processor is configured with processor-executable instructions to perform operations such that adjusting the polling frequency comprises decreasing the polling frequency in response to determining that communication device endpoint protection is active on the endpoint device.

29. The server of claim 24, wherein the processor is configured with processor-executable instructions to perform operations further comprising:
determining whether there are any suspicious endpoint device characteristics; and
adjusting the polling frequency based, at least in part, on a result of determining whether there are any suspicious endpoint device characteristics.

30. The server of claim 24, wherein the processor is configured with processor-executable instructions to perform operations further comprising:
determining whether the endpoint device is subject to network-based security measures; and
adjusting the polling frequency associated with the endpoint device based, at least in part, on a result of determining whether the endpoint device is subject to network-based security measures.
